(19) United States
(12) Patent Application Publication
(10) Pub. No.: US 2015/0222313 A1
(43) Pub. Date: Aug. 6, 2015

(54) AUTOMATED ARRANGEMENT OF A MOBILE APPARATUS IN EQUIPMENT

(71) Applicant: DELPHI TECHNOLOGIES, INC., TROY, MI (US)

(72) Inventors: Maxime Rassent, Strasbourg (FR); David Vayer, Ertsein (FR)

(21) Appl. No.: 14/406,868

(22) PCT Filed: Jun. 14, 2013
(86) PCT No.: PCT/EP2013/062451

§ 371 Date: Dec. 10, 2014

(30) Foreign Application Priority Data
Jun. 15, 2012 (FR) 1255634
Apr. 4, 2013 (FR) 1353040
Jun. 12, 2013 (FR) 1355429

(51) Int. Cl. H04B 1/3877

(52) U.S. Cl. CPC H04B 1/3877

(57) ABSTRACT

An arrangement for mounting of a mobile apparatus in equipment provided with a first movable support displaceable along a main axis, the first movable support being able to receive the mobile apparatus for it to be arranged in a location in which it is held in position by a holding device. The holding device is itself displaceable along a longitudinal axis between a retracted position in which the mobile apparatus can be placed in or removed from the location and an extended position in which the mobile apparatus is held in position in the housing. The equipment is in addition provided with a mechanical transmission means arranged between the movable support and the holding device so that the displacements of the mobile apparatus drives those of the holding device.

### CROSS-REFERENCE TO RELATED APPLICATION

This application claims the benefit under 35 U.S.C. §371 of published PCT Patent Application Number PCT/EP 2013062451, filed Jun. 14, 2013 and claims priority to French Patent Applications 1255634 filed Jun. 15, 2012; U.S. Pat. No. 1,353,040 filed Apr. 4, 2013; and U.S. Pat. No. 1,355,429 filed Jun. 12, 2013, and published as WO2013/186391 on Dec. 19, 2013, the entire contents of which is hereby incorporated by reference herein.

### TECHNICAL FIELD OF INVENTION

The present invention relates to the arrangement of a mobile apparatus, of mobile telephone or “smartphone” type or electronic tablet device, in equipment which may for example be an armrest or a central console of a vehicle. More particularly, the arrangement is effected with fixing, electrical connection, and connection to the network of the apparatus.

### BACKGROUND OF INVENTION

Devices are known permitting the installation of a mobile apparatus of mobile telephone with touchscreen or “smartphone” type in various equipment, for example a seat armrest or a central console of a motor vehicle.

Application FR1255634 teaches a particular arrangement in which the visible surface of the mobile apparatus, generally the touchscreen, is in surface continuity with the surface of the equipment. Moreover, when the mobile apparatus is removed, a cover is automatically placed in position not allowing the empty location intended for the mobile device to be seen. The arrangement can in addition be provided with a means which retains the mobile apparatus in position in its location.

Application FR1343040 teaches an arrangement provided with a holding device and a device for electrical connection of the mobile apparatus, the two devices being manually activated once the apparatus is placed in position, the delicate manipulation of the apparatus intended to place it exactly in position being able to attract and retain the attention of a vehicle driver.

Application FR1355429 teaches an arrangement provided with motorization and a control device permitting connection and a fixing of the mobile apparatus by simple depression.

This latter version remains dependent on an electrical connection to power the motor.

### SUMMARY OF THE INVENTION

The present invention is intended to resolve these problems by proposing an arrangement for the mounting of a mobile apparatus in equipment having a decorative fascia, particularly in a motor vehicle. The decorative fascia being provided with an opening giving access to a housing able to receive the mobile apparatus. The arrangement comprises a base fixed to the bottom of the housing, a movable support, displaceable relative to the base between a depressed position in which it is close to the base and an empty position in which it is distant from the base. The movable support has a main wall able to receive the mobile apparatus. It also comprises a retaining device which holds the movable support, in its empty and depressed positions so that in the depressed position the front face of the mobile apparatus appears through the opening and is in surface continuity with the decorative fascia of the equipment and, in the empty position. The main wall of the movable support appears through the opening and is in surface continuity with the decorative fascia of the equipment.

The arrangement comprises in addition an elastic means arranged between the movable support and the base the elastic means permanently biasing the movable support towards the empty position.

The movable support comprises a generic support independent of the model of mobile apparatus, and an interchangeable thickness adapter specific to a particular model of the mobile apparatus. The thickness adapter is arranged on the generic support its thickness is selected depending on the thickness of the mobile apparatus so that in the depressed position the front face of the mobile apparatus of the said model is in surface continuity with the decorative fascia.

The arrangement comprises in addition an interchangeable peripheral adapter specific to a particular model of mobile apparatus. The peripheral adapter is arranged and fixed in the opening of the housing and is itself provided with an opening specific to the dimensions of the model of mobile apparatus. The mobile apparatus A is placed in position its front face entirely obturates the specific opening while being in surface continuity with the decorative fascia of the equipment.

The retaining device comprises a cam and a finger, the cam being attached to the movable support or to the base and the finger being attached to the base or the movable support respectively. The cam and the finger cooperate so that in a determined relative position of the cam and of the finger, the movable support is retained in the depressed position.

The retaining device comprises a stop attached to the movable support which cooperates with an abutment surface attached to the decorative fascia so as to retain the movable support in the empty position.

The main wall of the movable support includes a detachable and interchangeable decorative cover.

The arrangement comprises in addition a device for holding in position the mobile apparatus in the location.

The device comprises a plate displaceable between an open position in which the mobile apparatus can be placed in or retracted from the location and a closed position in which the mobile apparatus is held in position in the location.

The holding device is provided with an elastic means which in the closed position of the plate applies a force to the mobile apparatus so that the mobile apparatus A is held in position.

The arrangement comprises in addition a second elastic means arranged on the plate so that in the closed position of the plate the elastic means applies to the mobile apparatus concurrent forces applied at its corners so as to adjust the position of the mobile apparatus in the location.

The arrangement comprises in addition an electrical connector attached to the mobile apparatus so that the apparatus can be electrically recharged and be connected to an electronic network comprising other electronic devices. The connector is arranged on the plate so that, in the open position, the connector is distant from the mobile apparatus and, in the closed position the connector is moved towards and complementarily connected to the mobile apparatus.

The arrangement comprises in addition a cam track against which is permanently biased a cam follower the said track, the follower reciprocally, being attached to the plate while the follower, the track reciprocally, is attached to the equipment, the follower travelling along the cam track between a first position reached when the plate is in the open position and a second position reached when the plate is in the closed position, the cam track being provided with at least one positioning notch in which the follower is engaged in the closed position of the plate so as to stabilize the said closed position.

The arrangement comprises in addition a grasping means attached to the plate so that a user can manually displace the plate between the open and closed positions.

The arrangement comprises in addition an automatic motorized or magnetic means for displacement of the holding device.

The arrangement comprises in addition an electrical actuator controlling the displacements of the holding device and of the connector.

The displacements of the holding device and of the connector are controlled by the same actuator which is an electric motor provided with transmission means connecting the said electric motor, the holding device and the connector so that the holding device and the connector are driven in coordinated manner and that therefore in the retracted position of the holding device the connector is disconnected and, in the extended position the connector is connected.

The arrangement comprises in addition a means for controlling the actuator so arranged that it is powered when the movable support is in the depressed position. The control means comprises a position sensor of the movable support. The position sensor is an electrical contactor arranged at the bottom of the housing and actuated by the movable support when this arrives in the depressed position.

The control means comprises in addition a presence detector of the mobile apparatus on the movable support so that, in the empty position of the movable support, the presence of a mobile apparatus causes the automatic displacement of the movable support towards the depressed position.

The arrangement can alternatively comprise a mechanical transmission means comprising a second support movable in translation along the main axis arranged cooperating with the first movable support, the second movable support being provided with a location in which the holding device is arranged slidingly along the longitudinal axis.

The mechanical transmission means comprises in addition a rod-crank system transmitting and transforming the displacements of the second movable support along the main axis into longitudinal displacements of the holding device.

The invention also relates to a kit for installation of a mobile apparatus of a particular model in equipment provided with a decorative fascia and with an arrangement formed in accordance with the claim. The kit comprises a thickness adapter which can be arranged on the movable support, the thickness adapter having the dimensions specifically suited to the model of mobile apparatus and a peripheral adapter being able to be arranged and fixed in the opening of the housing and itself being provided with an opening specific to the dimensions of the model of mobile apparatus.

### BRIEF DESCRIPTION OF DRAWINGS

Other characteristics, aims and advantages of the invention will become apparent on reading the following detailed description and with reference to the attached drawings, given by way of non-limiting example and in which:

FIG. 1 is a general view of the interior of a vehicle, a mobile apparatus of telephone type being arranged in equipment itself arranged in the central armrest and, as an illustrative example, another mobile apparatus of tablet type is in the front of the console.

FIG. 2 is an enlarged detail of the end of the armrest of FIG. 1, the mobile apparatus being placed in position.

FIG. 3 is similar to FIG. 2, the mobile apparatus being removed.

FIG. 4 is an exploded view of the arrangement of FIG. 1.

FIG. 5 is a section of the arrangement of FIG. 1 in which is placed a first model of mobile apparatus.

FIG. 6 is similar to FIG. 5, the mobile apparatus being removed.

FIG. 7 is a section similar to FIG. 5 but specifically adapted to a mobile apparatus of a second model thinner and less wide than the first model that of FIG. 3.

FIG. 8 is similar to FIG. 7, the mobile apparatus being removed.

FIG. 9 is the detail in perspective of a cam provided with a heart-shaped track traveled by a finger, these two elements being shown in the arrangement of FIG. 4.

FIGS. 10 to 14 illustrate the operation of the heart-shaped cam and of the finger of FIG. 9.

FIGS. 15 to 16 illustrate an embodiment of a device for holding and connecting the apparatus in the housing.

FIGS. 19 to 30 illustrate an embodiment of a motorized device for holding and connecting the apparatus.

FIGS. 31 to 34 illustrate a manual device for holding and connecting the apparatus.

### DETAILED DESCRIPTION

In the remainder of the description, identical or similar elements are designated by the same references.

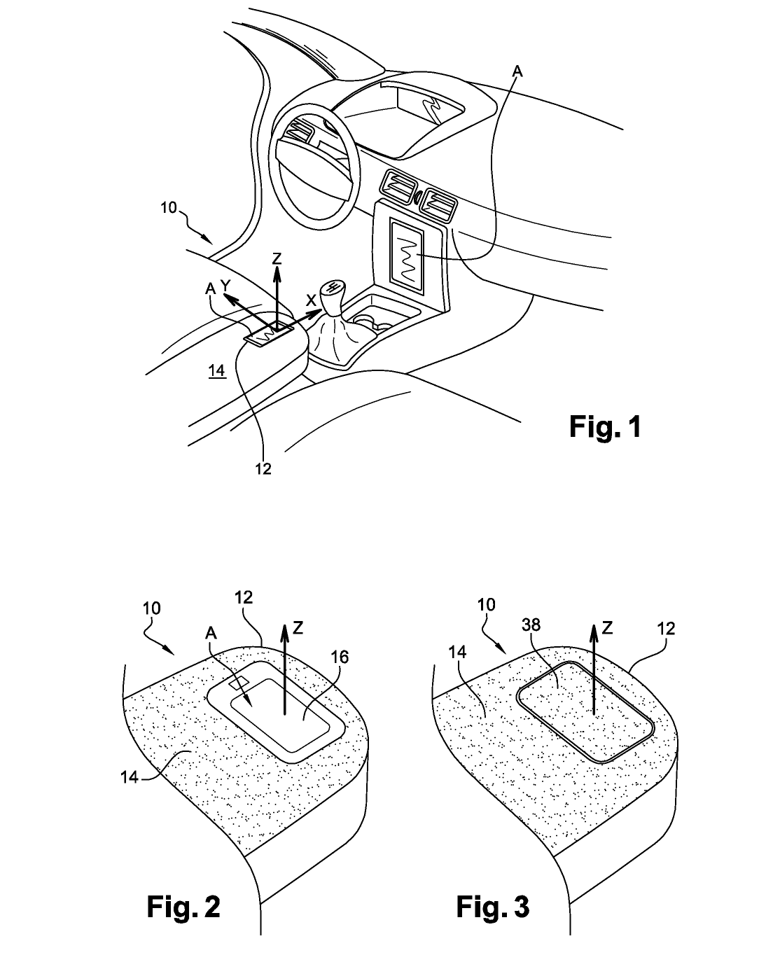

FIG. 1 shows the driving position of a car in the central armrest of which an arrangement 10 allows integration of a mobile apparatus A in equipment 12. The apparatus A is substantially rectangular and its length is orientated along a longitudinal axis X and the front face 16 is normal to the main axis Z. A transversal axis Y completes the Cartesian coordinate system, the width of the mobile apparatus being aligned along this axis. By way of illustration, in the figure a mobile apparatus of greater size, of electronic tablet type, is also placed in a quasi-vertical position. The description which follows is based on that of the horizontal apparatus but a transposition to the vertical apparatus is instant.

The object of the invention is not limited either to the motor vehicle environment and the arrangement 10 can be perfectly suitable for an armrest of an armchair, for the center of a steering wheel, for a dashboard or any other equipment, whatever it be, provided that it has available a location in which the mobile apparatus can be installed.

Mobile apparatus are conventionally parallelepipedal rectangles with slightly rounded corners and, without limiting the invention to this shape; it will be used by way of illustration of the description. In the description will be referenced the width La, smaller dimension of the front face 16, the length Lg larger dimension of the front face 16 and the thickness ep1 dimension of the front face 16 to the back of the apparatus A.

Lastly, still for the sake of clarity and simplification, an orientation from bottom to top along the main axis Z will be adopted. Thus the terms “bottom”, “top”, “above”, “below”, “upper”, “lower” and “horizontal” and “vertical” can be used in the description without thereby limiting the invention, particularly taking into account the multiple possibilities of integration of a mobile apparatus in equipment.

As shown in FIGS. 2 and 3 the apparatus A can be orientated in various manners in the armrest of FIG. 1, which armrest is provided with a decorative fascia 14.

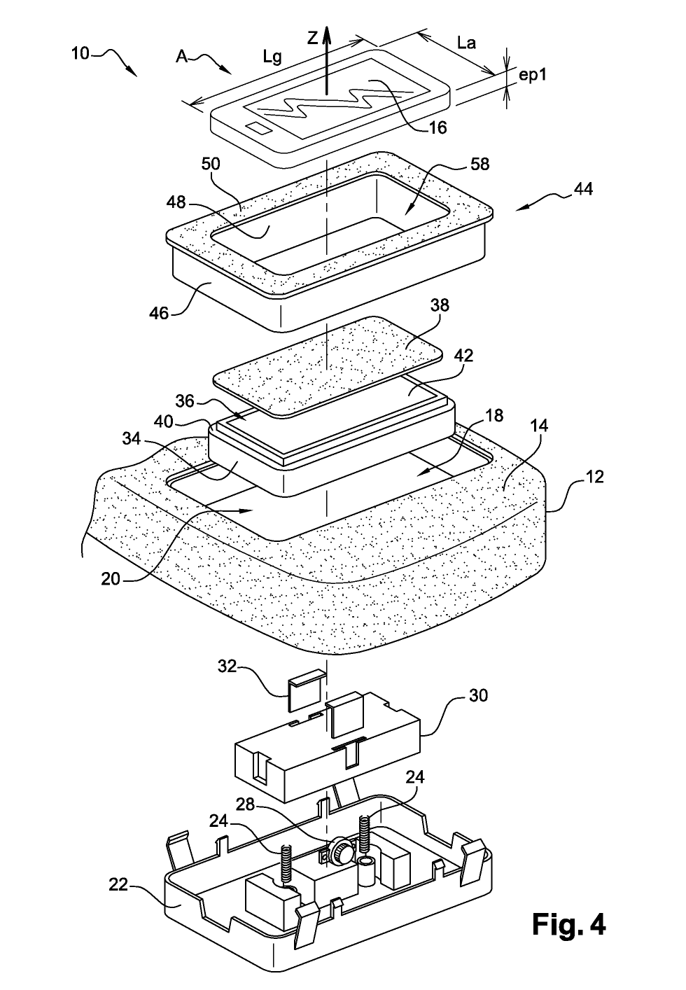

The elements of the arrangement 10 are now described with reference to FIG. 4.

The equipment 12 is provided with a rectangular opening 18 giving access to a hollow housing 20. The teachings of the invention can obviously be applied to any other corresponding shapes particularly a circular, oval or other apparatus.

A base 22 is fixed to the bottom of the housing 20. The base 22 shown can be installed by passing it through the opening 18. Once at the bottom of the housing 20, tongues, four in FIG. 4, expand elastically from the base 22 and arrange themselves in housings in the peripheral walls of the housing 20. Other devices are possible such as a base fixed by screws to the bottom of the housing. The base 22 is provided with two compression springs 24, with a finger 26 mounted at the end of an oscillating arm and with a damper 28. Alternatively other elastic means can be used.

A movable support 30, itself provided with a cam 32 fits on the base 22, compresses the springs 24 and sits on the damper 28. In a preferred but not exclusive embodiment, the cam 32 is a cam defining a heart-shaped track in which fits the finger 26. The cam and the finger are described below and illustrated by FIGS. 9 to 14. Moreover in FIG. 4, the movable support 30 and the cam 32 are two different pieces, but once assembled they are attached. An integral construction, made in one piece, of the movable support and the cam is of course possible.

A thickness adapter 34 is arranged on the movable support 30. The thickness adapter 34 has a main wall 36 of thickness ep2 perpendicularly bordered by lateral walls. Once in position the thickness adapter 34 sits on and covers the movable support 30. The main wall 36 is rectangular, not a limiting shape as explained above, and is bordered by a narrow surround 40 slightly rebated in thickness relative to the central zone 42. The central zone 42 has the dimensions La×Lg of the mobile apparatus A which is to be installed.

A rectangular decorative cover 38 of small thickness ep3, the main dimensions La×Lg of which are also those of the apparatus A and of the central zone 42 is arranged and fixed on the central zone 42 of the thickness adapter 34.

A peripheral adapter 44 is arranged and retained in the opening 18 of the housing 20. The peripheral adapter 44 has the form of a rectangular crown of which the external lateral edges 46 and the internal lateral walls 48 are connected by a horizontal upper face 50 slightly overlapping internally and externally. The external lateral walls 46 have dimensions matching those of the opening 18 so that complementary engagement of the pieces is effected. The internal lateral walls 48 have dimensions matching those of the thickness adapter 34 so that the latter can be displaced without damage.

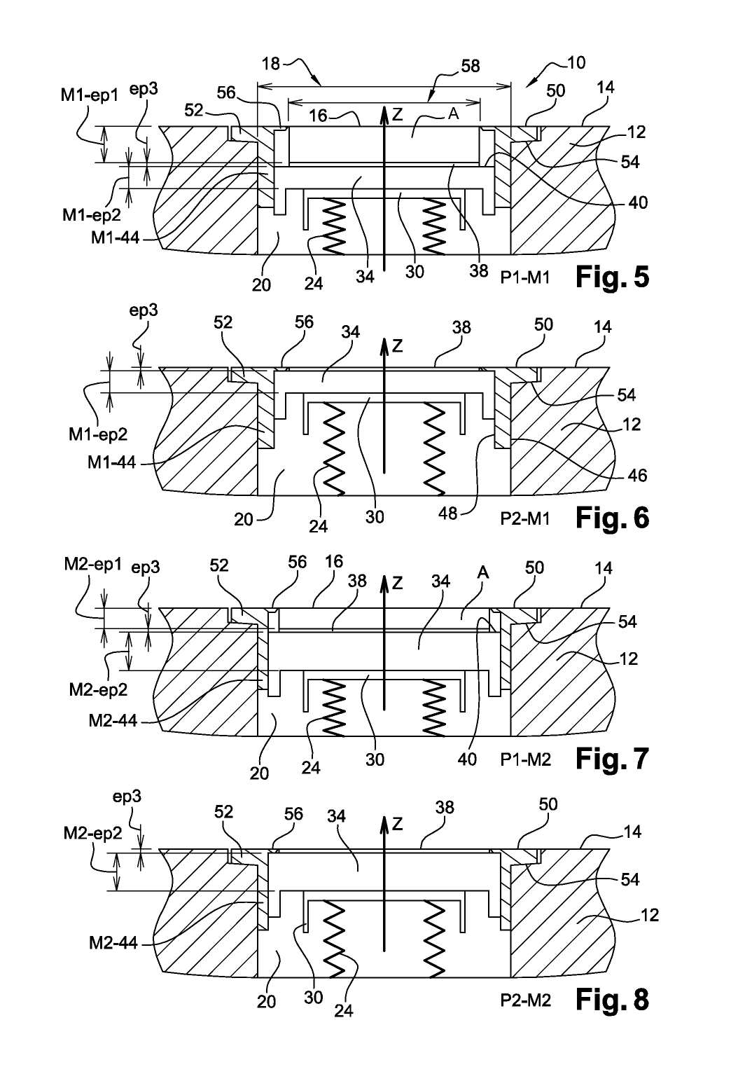

More easily seen in FIGS. 5 to 8, the peripheral adapter 44 is placed in position in the opening 18 in a complementary arrangement. The external overlap 52 of the upper face 50 fits perfectly into a slight rebate 54 in the decorative fascia 14, which slight rebate 54 borders the circumference of the opening 18. This complementary engagement ensures that the peripheral adapter 44 is positioned exactly in the opening 18, the upper face 50 then being in surface continuity with the decorative fascia 14. Moreover, the peripheral adapter 44 and the internal overlap 56 of the upper face 50 restrict the opening 18 to a specific opening 58 the dimensions of which are those, La, Lg, of the mobile apparatus A, of the decorative cover 38 and of the central zone 42 of the main wall 36 of the thickness adapter 34.

The operation of the system is now described with reference to FIGS. 5 to 8.

FIGS. 5 and 6 show the arrangement 10 specifically designed for the first model M1 of smartphone A. This first model M1 being distinguished from a second model M2, selected to illustrate FIGS. 7 and 8, by its width and its thickness which are different. The operation remains identical.

These figures show the mounting of the peripheral adapter 44 in the opening 18 particularly with the complementary arrangement of the external overlap 52 in the slight rebate 54 of the decorative fascia 14. The arrangement 10 comprises the stack of the decorative cover 38, of the thickness adapter 34, of the movable support 30, of the compression springs 24 and of the base 22. Thus mounted the decorative cover 38 the thickness adapter 34 and the movable support 30 can be displaced along the main axis Z.

FIGS. 5 and 7 correspond to a depressed position P1. The mobile apparatus A is in position, the springs 24 are compressed and the movable support 30 is close to the base 22.

FIGS. 6 and 8 correspond to an empty position P2. The mobile apparatus A is removed, the springs 24 are less compressed than before and the movable support 30 is distant from the base 22.

In FIGS. 5 and 7, the apparatus A is in position on the decorative cover 38. The front face 16 of the apparatus A appears through the specific opening 58 of the peripheral adapter 44 and obturates it entirely. The front face 16 is in surface continuity with the decorative fascia 14 of the equipment 12 and with the upper face 50 of the peripheral adapter 44.

In FIGS. 6 and 8, the apparatus A is removed. The decorative cover 38 appears through the specific opening 58 of the peripheral adapter 44 and obturates it completely. It is in surface continuity with the decorative fascia 14 of the equipment 12 and with the upper face 50 of the peripheral adapter 44.

In FIGS. 5 and 7, the assembly is held in this depressed position P1 by the heart-shaped cam 32 and the finger 26. This type of mechanism is known and the operation is now briefly described with reference to FIGS. 9 to 14. Other arrangements exist to fix the positions of the movable support 30.

The cam 32 is provided with a heart-shaped track along which travels the finger 26 so that in the empty position P2, the finger is at the bottom convex point L1 of the heart.

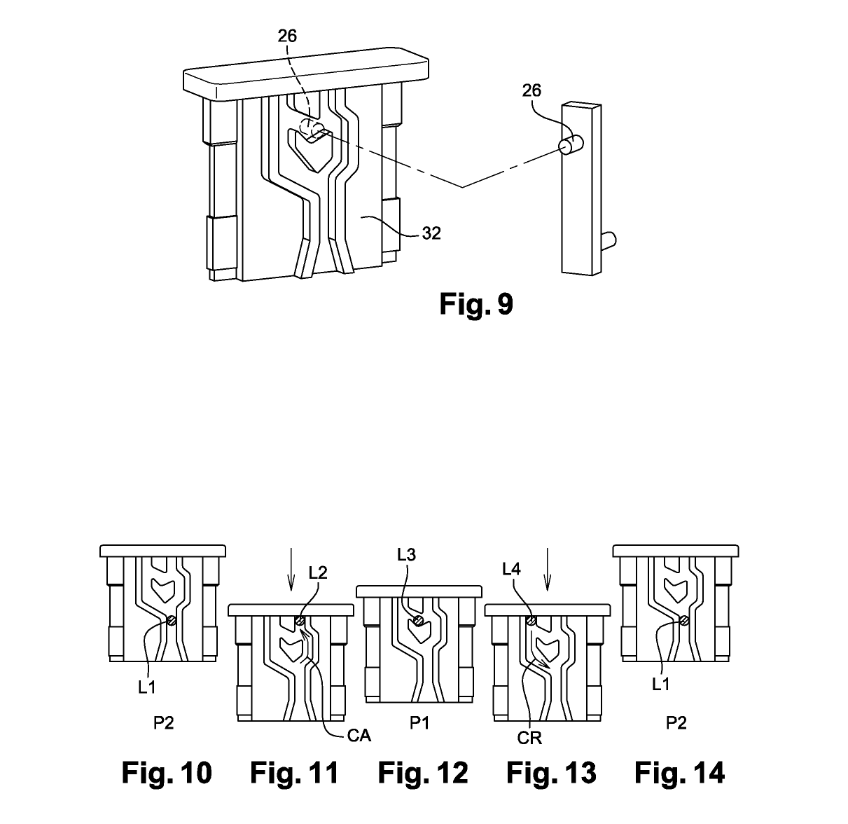

To place the mobile apparatus A in position, the arrangement being in the empty position P2—FIG. 10—a user places the apparatus A on the decorative cover 38 and presses on the front fray 16 in the direction of the arrow in FIG. 11 along the main axis Z. The movable support 30 and the cam 32 are displaced, the finger 26 then travels along an outward track CA passing through a first zenithal position L2 at the top of a first lobe of the heart. The apparatus A is then entirely entered in the housing 20, its front face 16 being depressed relative to the decorative fascia 14. The damper 28 is placed on the base in order to prevent a sharp shock if the user presses a little heavily on the apparatus A. Then the user releases his pressure and, biased by the springs 24, the movable support 30 rises again—FIG. 12—the finger 26 following along the outward track CA until it lodges in the concave point between the lobes L3 then retaining the movable support 30 in the depressed position P1.

To remove the apparatus A, a pressure on the front face 16, in the direction of the arrow in FIG. 13 along the main axis Z, again depresses the movable support 30, the finger 26 is then displaced along a return track CR from the concave point between the lobes L3 up to a second zenithal position L4, at the top of the second lobe of the heart. The apparatus A is then again entirely entered in the housing 20, its front face 16 being depressed relative to the decorative fascia 14. Here also the damper 28 can lessen the effect of a rather sharp pressure. Then—FIG. 14—the user releases the pressure applied and, biased by the springs 24, the movable support 30 rises again until the periphery 40 of the peripheral adapter 34 comes into abutment under the internal overlap 56 of the upper face 50 of the peripheral adapter 44. The finger 26 has followed the return track CR until it again returns into the convex bottom point L1 of the heart. The movable support 30 is then held in the empty position P2 and the apparatus A can easily be removed.

The model M1 of smartphone—FIG. 5—is thicker than the model M2—FIG. 7. Therefore with each model corresponds a specific thickness adapter 34 the thickness ep2 of which compensates for that of the apparatus ep1 and ensures that in the depressed position P1 the front face 16 is in surface continuity with the decorative fascia 14.

Similarly, the model M1 of smartphone—FIG. 5—is less wide La than the model M2—FIG. 7. With each model therefore corresponds a specific peripheral adapter 44 the specific opening 58 of which corresponds exactly to the dimensions of the front face 16 of the corresponding model so that in the depressed position P1, the front face 16 of the apparatus A completely obturates the specific opening 58.

In the empty position P2, a surface continuity between the decorative fascia 14 and the decorative cover 38 is desirable. To obtain this the thickness of the internal overlap 56 must be equal to that of the decorative cover 38. Alternatively, other constructions can be selected taking into account the dimension stack of the arrangement.

In several places in this description mention is made of a complementary engagement of pieces which have equal dimensions. For example, the front face 16 or the decorative cover 38 obturates the specific opening 58. The arrangement in the armrest of FIG. 1 positions the mobile apparatus A quasi-horizontally. The apparatus is then naturally held in position in the housing 20. It remains important to prevent accidental removal for example due to passage over a bump in the road, a ridge or a hump, a pothole or any kind of unevenness. To this end, the dimensions of the specific opening 58 are so adjusted that the front face 16 of the mobile apparatus A is slightly jammed between the internal overlaps 56. On the other hand, the decorative cover 38 being fixed onto the thickness adapter 34 it does not risk accidental removal and then its own dimensions are so selected as to maintain a very slight play between the decorative cover 38 and the specific opening 58.

The man skilled in the art will be able to select the dimensions so that the slight jamming and the slight play do not detract from the proper functioning of the arrangement.

The slight jamming of the front face 16 in the specific opening 58 is a first embodiment of a holding means 62 of the mobile apparatus A in the housing 20. In the case in which this first embodiment is not considered adequate for example in the case of vertical integration in the center of the steering wheel or even a “head-down” integration with the front face 16 orientated downwardly, and additional holding means 62 can be provided. This additional holding means 62 may be formed in accordance with various embodiments particularly using the placing of the mobile apparatus in position and therefore the depression of the movable support 30 to actuate the tilting of lateral friction pads fitting between the internal lateral walls 48 of the peripheral adapter 44 and the sides of the mobile apparatus A. The tilting of the pads can be replaced by jamming by compression caused by means of springs or otherwise. Clamps can also close, like the jaws of a pair of pliers, on the sides of the mobile apparatus. A device can also be designed to encircle and retain the apparatus. Whatever it may be, the additional holding means 62 must not be visible to the user so as to retain the appearance of continuity of the surfaces.

Also, the description does not specify that the dimensions of the mobile apparatus A include the possible rounding of the corners. Thus the specific opening 58 is rectangular but may be provided with rounded corners if the model of mobile apparatus is so formed.

The most general embodiment of construction has been described. Alternative embodiments can also be formed following the teachings of the present invention.

In accordance with a second embodiment of construction the decorative cover 38 is formed in one piece with the thickness adapter 34. In this case, in the empty position P2, the main wall 36 of the thickness adapter 34 appears through and is in surface continuity with the decorative fascia 14. In accordance with this second embodiment the replacement of the thickness adapter 34 is necessary to suit for example the aesthetics of the arrangement 10 to the decorative fascia 14.

In a third embodiment of construction specifically designed for a single model of mobile apparatus A, the thickness adapter and the peripheral adapter are eliminated, the decorative cover 38 is directly fixed onto the movable support 30, or even made in one piece with it, the opening 18 formed in the decorative fascia 14 directly has the specific dimensions of the said model of smartphone.

In a fourth embodiment of construction, similar to the first embodiment, the most general, the peripheral adapter 44 can be arranged in the opening in two perpendicular directions so as to place the apparatus A in the portrait position or in the landscape position. To achieve this, the opening 18 of the housing 20 can be of square section, the external lateral walls 46 of the peripheral adapter 44 forming a complementary square. The specific opening 58 remains a rectangle with the dimensions of the front face 16. The other adaptations particularly those of the thickness adapter 34 remain within the scope of the man skilled in the art.

In a fifth embodiment of construction, intended for any angular positioning of the front face 16, the opening 18 of the housing 20 can be circular and the peripheral adapter 44 can have complementary circular external walls while the specific opening 58 remains a rectangle with the dimensions of the front face 16 of the apparatus A. The other adaptations particularly those of the thickness adapter 34 remain within the scope of the man skilled in the art.

The thickness adapter, the peripheral adapter, and the decorative cover, which are pieces specific to a given model of mobile apparatus A, can be the object of specific kits provided separately. On a change of apparatus A it is then sufficient to integrate a new apparatus in the equipment 12 to obtain a kit corresponding to the new apparatus and to only replace the thickness adapter 34, the peripheral adapter 44 and the decorative cover 38. Similarly the decorative cover can be supplied alone in a separate kit so as to replace a worn cover or to match the arrangement 10 to a new decorative fascia 14.

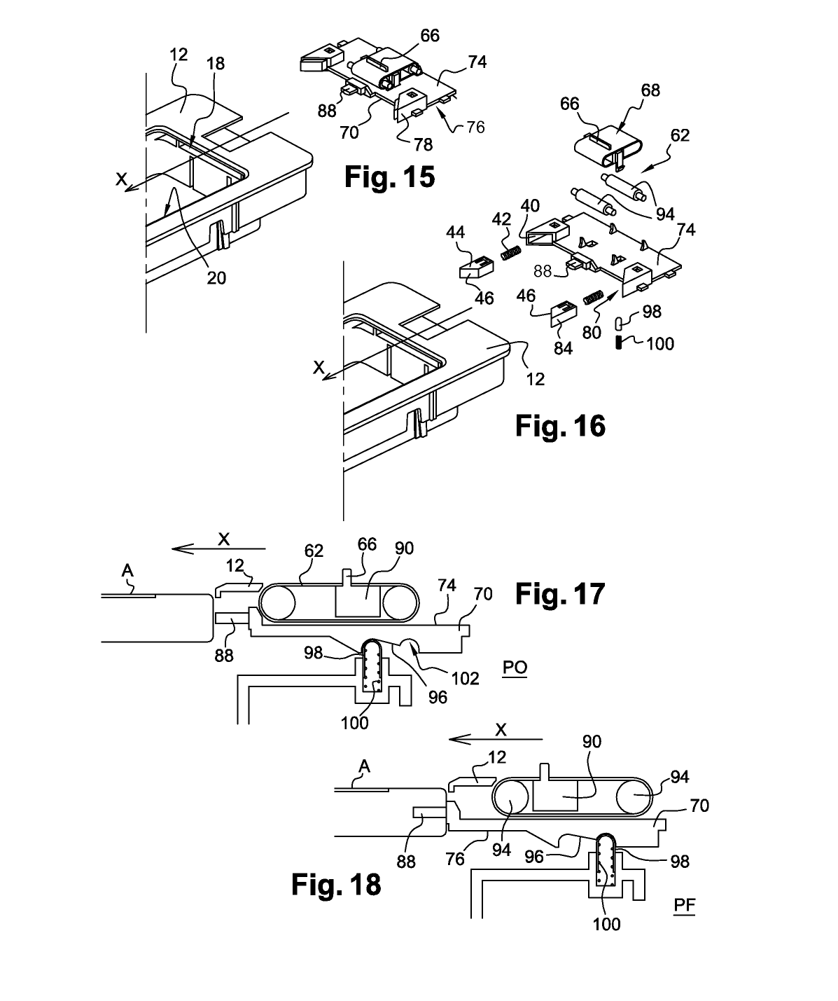

An embodiment of the holding device 62 is now described with reference to FIGS. 15 to 18. The device 62 is manually actuated by means of a tongue 66 protruding vertically just above another concealing means 68 described below.

The holding device 62 comprises a flat and substantially rectangular plate 70, its long side 72 being of the dimension of the width of the mobile apparatus A. The plate 70 is arranged horizontally and is displaceable in translation along the longitudinal axis X. The tongue 66 is attached to the plate 70 and extends perpendicularly from it. In the two corners 78 of the plate 70 situated closest to the mobile apparatus A, the plate 70 is provided with two housings 80 in each of which is arranged a compressed spring 82 longitudinally X biasing a beveled block 84 in the form of a right-angled trapezoid, the two slanted sides 86 of the blocks 84 being so orientated as to be applied at the rounded corners of the mobile apparatus A. Alternatively, a profiled leaf spring could be provided which, approaching the plate would be in contact with the mobile apparatus A or a rubber seal.

At the center of the long side 72 of the plate 70 closest to the mobile apparatus A is arranged a male electrical connector 88. This connector 88 having the object of being engaged in the female connector of the mobile apparatus A, it is obvious that the form and very location on the plate 70 of the male connector 88 depends on the model of mobile apparatus A selected and, in the case of a mobile apparatus A having an off-center female connector, the corresponding male connector 88 would be correspondingly arranged on the side of the plate 70. The electrical connector 88 is itself connected by means of a cable, not shown, to the power circuit and to the computer network of the vehicle so as to provide the connection of the mobile apparatus A both for electrical recharging and for access to the set of functionalities.

Lastly, at the center of the plate 70 is arranged a tongue 66 as well as the said other concealing means 68. The tongue 66 is part of a parallelepipedal block 90 extending transversally Y to be attached to the plate 70 by means of two legs terminating in a lug engaging in complementary openings in the plate 70. Between the plate 70 and the block 90 is formed a thin passage in which passes a continuous band 92 stretched between two rollers 94 attached to the arrangement 10 and turning about the transversal axis Y. The band 92 is provided with a small slot through which protrudes the tongue 66. Thus arranged, a user can displace the plate 70 by acting on the tongue 66 so that when a user pushes the tongue 66, the band 92 turns about the rollers 94, the block 90 is displaced and drives the plate 70. As it turns the band 92 continuously conceals the opening necessary for the displacement of the said tongue 66. Other means can be developed for example by eliminating the tongue and acting directly on the band. This, under the pressure applied by the user, is slightly deformed and comes into contact with the parallelepipedal block 90 which is displaced and drives the plate 70. In similar manner, the band can be stuck, or fixed in any manner to the upper face of the block so that without deformation the driving of the band displaces the block 90 and the plate 70.

As can be seen particularly in FIGS. 17 and 18, the plate 70 is provided on its lower face 76 with a cam track 96 against which is biased a follower finger 98 pushed by a vertical spring 100. Alternatively another similar device can be used by replacing the finger with a ball bearing or a leaf spring for example. The cam track 96 is moreover provided at one end with a closure notch 102. Thus arranged, when the plate 70 is in the open position PO—FIG. 17—it is distant from the mobile apparatus A, the electrical connector 88 is disengaged from the apparatus A and the follower finger 98 is at the end of the cam track 96. To displace the plate 70 by means of the tongue 66, the user must push the tongue along the longitudinal axis X so that the cam track 96 is displaced and is traveled along by the follower finger 98. At the limit of travel the plate 70 approaching the closed position PF, the electrical connector 88 engages complementarily in the connector of the apparatus A, the beveled blocks 84 come into contact with the rounded angles of the apparatus A and press so as to fix it in its housing 20 and the follower finger is lodged in the closure notch 102 thus fixing the said closure position moreover by engaging in the notch 102 the finger 98 transmits to the user a slight force which is both pleasant and assures the user that the connection has been properly made. As shown in FIGS. 17 and 18, the cam track 96 can be so profiled that the user thus senses a force, the cam track 96 is inclined so that in the closure direction the user has to overcome an increasing force followed by a slight “click” on engagement of the finger 98 in the notch 102 and, in the opening direction, on the other hand, the user only has to provide the force necessary to the disengagement of the finger 98 from the notch 102, the action of the finger 98 on the cam track 96 then being driving until the plate is in the open position PO. Moreover not shown, the cam track can be provided with an opening notch in which the finger 98 is engaged in the open position PO of the plate 70.

The profile of the cam track 96 and the opening and closure notches have complementary roles. It is useful for the open PO and closed PF positions to be stable positions. In accordance with FIGS. 17 and 18, the stability is provided in the closed position PF by the engagement of the finger 98 in the closure notch 102 and in the open position PO on the one hand by the end of the cam track 96 against which the finger 98 comes into abutment and on the other by the slope of the cam track 96. Following the example of the open position PO a cam track could be designed in a V-shape, with a very open and rounded V, terminated by two stops such as opening in FIGS. 17 and 18.

The manual displacement means described above can be replaced by an automatic means for example motorized or magnetic.

The kit 60 described above can also comprise the holding and connection device described above.

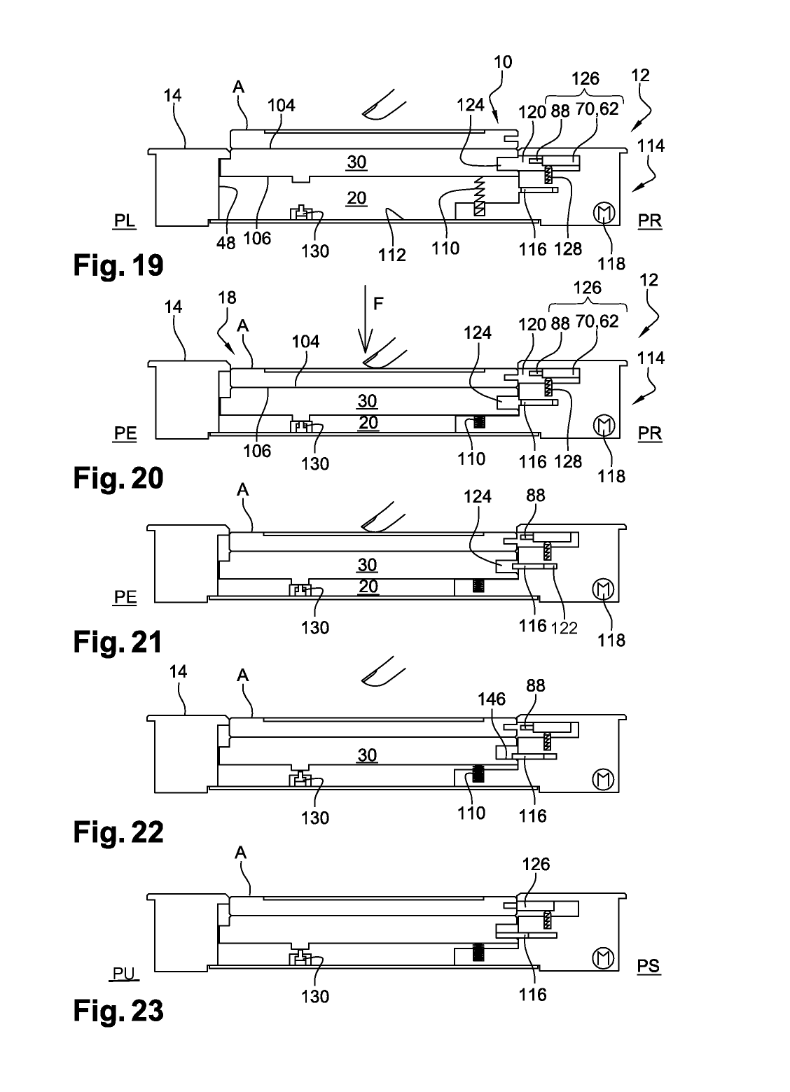

A particular embodiment of a motorized device is now described with reference to FIGS. 19 to 30.

In accordance with this embodiment, the equipment 12 is provided with a decorative fascia 14 coordinated with the armrest. The opening 18 of the equipment 12 gives access to the parallelepipedal housing 20 in which the mobile apparatus A can be placed. The movable support 30 is arranged in the housing 20 and can be displaced there vertically Z between an empty position PL, as in FIG. 19, in which position the upper face 104 appears through the opening 18, the mobile apparatus A being just placed on the upper surface 104, and a depressed position PE—FIG. 20. The movable support 30 is itself parallelepipedal, it comprises the upper face 104 of which the dimensions are substantially those of the opening 18, an opposite lower face 106, the faces 104, 106 being connected by four lateral walls 108. A spring 110, or alternatively any other elastic means, arranged between the lower face 106 and the bottom 112 of the housing 20 permanently biases the movable support towards the empty position PL. In the embodiment described, the spring 110 is held in position by means of a hollow location provided in the bottom of the housing. The movable support 30 is moreover provided with a locking notch 128 extending transversally Y in the thickness itself of the transversal lateral wall 108 shown on the right in FIG. 19. The opposite lateral wall, the “left” wall of FIG. 19, is provided in its lower part with an extension which permits a complementary engagement with a rim of the opening 18. This engagement enables in the empty position PL the movable support 30 to come into abutment against the said room and, although biased vertically Z by the spring 110, it is immobilized, the upper face 104 appearing through the opening 18.

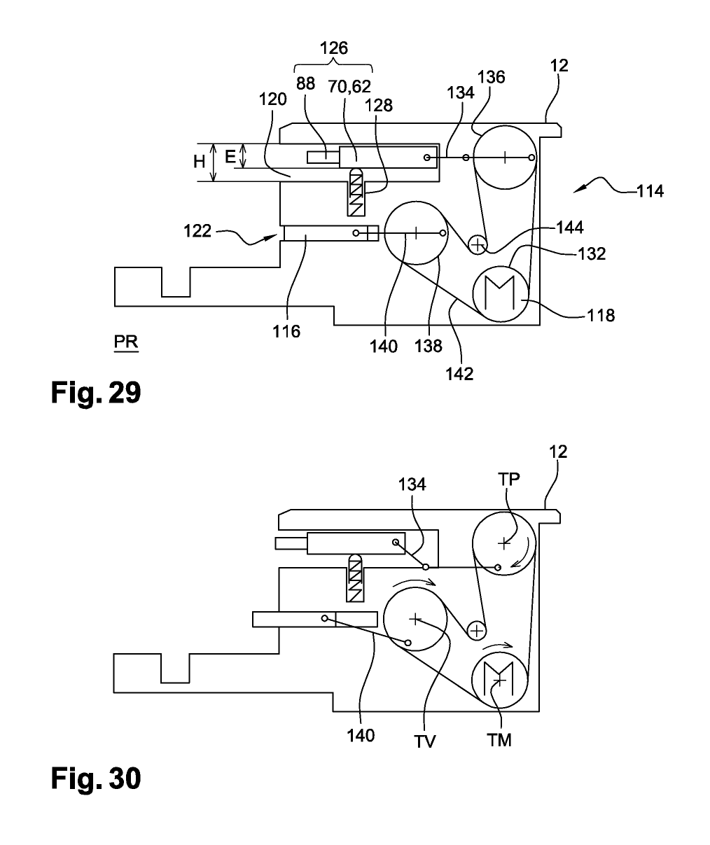

In the vicinity of the right width of the housing 20, equipment 12 is provided with a control space 114 in which is arranged the plate 70 as described above, equipped with the holding device 62 and the electrical connector 88 suited to the model of mobile apparatus A. In addition a positioning bolt 116, an electric motor 118 and a transmission means which will be described in detail with reference to FIGS. 29 and 30.

As presented in FIG. 19, the equipment 12 comprises in the control space 114 a top housing 120 in which are arranged the holding device 62 and the electrical connector 88 and a bottom housing 122 in which is arranged the bolt 116. When the movable support 30 is in the empty position PL—FIG. 19—the top housing 120 is facing the locking notch 124 which both have the same height H, which height is measured along the vertical axis Z.

In the top housing 120, the holding device 62 and the connector 88 are attached to the plate 70 thus together forming an equipped plate 126 of which the thickness E measured along the vertical axis Z is distinctly less than the height H of the top housing 120. Another spring 128 provided with a tip facilitating the relative slidings and displacements is arranged under the equipped plate 126 and permanently vertically Z biases it towards the top of the top housing 120 which will also be called the “ceiling” of the top housing 120.

As will be described in more detail further on, the equipped plate 126 is movable in the top housing 120 and can be displaced longitudinally X and vertically Z.

The bolt 116 for its part is adjusted sliding in the thickness of the bottom housing 122 and can only be displaced there along the longitudinal axis X.

In the empty position PL of the movable support 30, such as in accordance with FIG. 19, the equipped plate 126 is in a retracted position PR entirely inside and at the top of the top housing 120. The bolt 116 is also in the retracted position PR entirely inside the bottom housing. As will be observed in FIG. 19 the bolt 116 is flush with the right wall of the housing 20 while the equipped plate 126 is set back from the said wall. Put colorfully, the bolt 116 is said to be more “advanced” than the equipped plate 126.

The longitudinal displacements X of the equipped plate 126 and of the bolt 116 are motorized by the electric motor 118 which has a control means comprising inter alia an electrical contactor 130. In the embodiment of FIG. 19, the contactor 130 is arranged on an electronic board positioned at the bottom of the housing 20 so that when the movable support 30 descends vertically Z up to the depressed position PE, its lower face 106 actuates the contactor 130 which switches electrically.

The steps of installation are now described with reference to FIGS. 19 to 23.

In accordance with FIG. 19, the mobile apparatus A is placed on the upper face 104 of the movable support 30 which is in the empty position PL. The said upper face 104 pushed vertically upwardly by the spring 110 is flush with the decorative fascia 14. The mobile apparatus A is therefore outside the housing 20. The locking notch 124 is facing the top housing 120. The equipped plate 126 and the bolt 116 are both in the position PR retracted inside their respective housings. Particularly, the equipped plate 126, vertically biased by the other spring 128 is up “at the ceiling” of the top housing 120.

In accordance with FIG. 20, the finger which was previously approaching is now in contact with the apparatus A and presses in the direction of the arrow F so as to cause the apparatus A to enter the housing 20. The lower face 106 of the movable support 30 then contacts the electrical contactor 130 which switches. The movable support 30 is in the depressed position PE. The equipped plate 126 and the bolt 116 remain in the retracted position PR. The locking notch 124 is lowered and is facing the bolt 116. The contactor 130 being pressed the motor 118 receives the corresponding information and starts to turn.

In accordance with FIG. 21 the motor 118 powered, since the contactor 130 has been switched, has started to rotate so that the equipped plate 126 and the bolt 116 have both started to advance longitudinally X. The bolt 116 being a little more in advance than the equipped plate 126, the bolt 116 engages in the locking notch 124 from the beginning of the longitudinal displacement X while the equipped plate 126 is still entirely in the top housing 120. The expression “a little more in advance” is interpreted in the sense that the bolt 116 is closer to the movable support 30 than is the plate 126. At this point of engagement of the bolt 116 the motor 118 stops and pauses and, in accordance with FIG. 22, the user ceasing his action on the apparatus A, the latter rises back slightly vertically Z under the influence of the spring 110, but the bolt 116 being partially engaged in the locking notch 124, it enters into contact with the bottom wall 146 of the said notch 124 and then retains the movable support 30 so that its lower face 106 is no longer in contact with the contactor 130 and the screen of the mobile apparatus A appears through the opening 18. In this position the connector 88 is facing the female connector of the mobile apparatus A and the movable support 30 no longer presses on the contactor 130 which switches again and, in accordance with FIG. 23, the movable support 30 now being retained by the bolt 116, the motor 118 starts to turn again and the equipped plate 126 as well as the bolt 116 pursue their longitudinal displacement X. The bolt 116 thus pursues its complete engagement in the locking notch 124 and the equipped plate 126, still at the “ceiling” of the top housing 120, pursues its engagement in the apparatus A so that the male connector 88 is plugged into the female connector of the mobile apparatus A, which is thus connected both for electrical recharging of its batteries and for a connection with the electronic network of the vehicle. The equipped plate 126 and the bolt 116 are in the extended position PS. The position of FIG. 23 is the use position PU of the mobile apparatus A installed in the equipment 12.

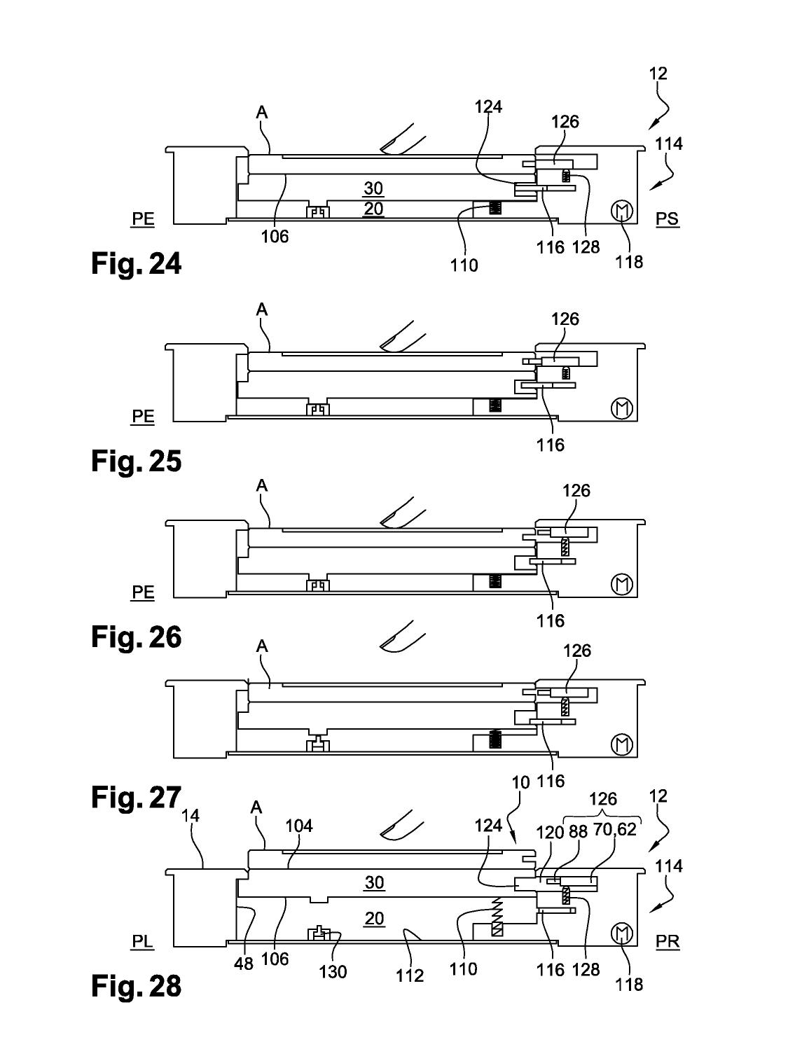

FIGS. 24 to 28 illustrate the steps followed to remove the mobile apparatus A from the equipment 12.

In accordance with FIG. 24, the user again presses on the mobile apparatus A, which has the effect of vertically Z depressing the apparatus A and the movable support 30 until the lower face 106 of the movable support 30 presses on the contactor 130 and causes it to switch while compressing the spring 110 which corresponds to returning to the depressed position PE. This vertical Z displacement has also driven the equipped plate 126 the connector 88 of which is still plugged into the apparatus A. In doing this the plate 126 has moved away from the ceiling of the top housing 120 and has compressed the other spring 128. The bolt 116 for its part is substantially in the middle of the locking notch 124. The contactor 130 having switched, the electric motor 118 is again powered and starts to turn in the opposite direction from before. It will be indicated below that in the configuration of FIGS. 29 and 30 the motor 118 could turn permanently in the same direction, without reversing.

In accordance with FIG. 25 the movable support is still in the depressed position PE but the equipped plate 126 and the bolt 116 have started to retract. The connector 88 is now only partially engaged in the apparatus A and the equipped plate 126 is entirely within the top housing 120, while still being in the proximity of or even in contact with the bottom surface of the top housing 120. The bolt 116 for its part is only partially retracted.

FIG. 26 follows FIG. 25 and the connector 88 is now entirely disengaged from the apparatus A. Under the influence of the other spring 128 alone, the plate 126 has been displaced vertically Z from the floor to the ceiling of the top housing 120.

In accordance with FIG. 27, the user is no longer pressing on the apparatus A, the electric motor 118 still powered pursues the retraction of the bolt 116 as well as the complete withdrawal of the equipped plate 126. While the bolt 116 remains, even partially, engaged in the locking notch 124 it retains the movable support 30.

In accordance with FIG. 28, identical to FIG. 19, the bolt 116 is entirely disengaged from the locking notch 124. The movable support 30 is no longer subject to the force of the spring 110 which acts vertically Z on its lower face 106 and which causes it to lift again until it is in the empty position PL of FIG. 19, in which position the apparatus A can be removed.

The motorization of the equipment 12 is now described with reference to FIGS. 29 and 30. The electric motor 118 is attached to the equipment 12. It is a rotary motor of which the central axis TM is transversal Y and directly drives a driving pulley 132 as well as a first driven pulley 136 of transversal axis TP, arranged behind the top housing 120, and a second driven pulley 138 of the same diameter as the first driven pulley 136, of transversal axis TV, arranged behind the bottom housing 122. The expression “behind” here designates a position longitudinally “to the right” in the context of FIG. 29. A belt 142 drives the pulleys in the same direction of rotation, without this being obligatory. Moreover, the belt 142 is kept under tension by a jockey-roller 144.

The first driven pulley 136 drives the plate 126 by means of a first rod-crank system 134. The rod is linked pivotably to the equipped plate 126 and the crank is linked pivotably to the pulley 136. The system 134 is so arranged that in the retracted position PR of the equipped plate 126, the rod and the crank are aligned along the longitudinal axis X, the anchoring pivot of the crank on the pulley 136 being as far back as possible and, in the extended position PS of the plate 126, the rod and the crank are still aligned along the longitudinal axis X, the anchoring pivot of the crank on the pulley 136 being as far forward as possible. Plus a half turn of the driven pulley 136 corresponds to the longitudinal X displacement of the equipped plate 126 traveled between the retracted PR and extended PS positions.

The second driven pulley 138 drives the bolt 116 by means of a simple crank 140. The crank is linked pivotably at each of its ends on one side to the pulley 138 and on the other to the bolt 116. The crank 104 is so arranged that in the retracted position PR of the bolt 116, it is aligned along the longitudinal axis X, the anchoring pivot of the crank on the pulley 138 being as far back as possible and, in the extended position PS of the bolt 116 the crank is again aligned along the longitudinal axis X, the anchoring pivot of the crank on the pulley 138 being as far forward as possible. Thus a half turn of the second driven pulley 138 corresponds to the longitudinal X displacement of the bolt 116 traveled between the retracted PR and extended PS positions. It appears here that the back and forth motions of the equipped plate 126 and of the bolt 116 can be the result of half turns of the motor 118, whether these half turns are effected by reversal of the direction of rotation or by continuing the same direction of rotation. FIG. 29 shows the device in the retracted position PR, while FIG. 30 shows it in an intermediate position such as in FIGS. 21, 22, 26 and 27, in which position the connector 88 is disengaged from the apparatus A while the bolt 116 is partially engaged in the locking notch 124.

The driven pulleys 136, 138 as well as their rod-crank 134 and crank 140 mechanism, must allow longitudinal displacements of the equipped plate 126 and of the bolt 116 which are simultaneous and of the same length. In the figures an embodiment is shown in which the pulleys are identical and the fastening pivots of the rods are similarly eccentric. Multiple alternatives to this motorization and movement transmission device can be employed, for example by replacing the rotary motor with linear motors or electromagnets, the motors being directly connected to the plate and the bolt.

The kit 60 can easily be augmented with motorized means such as described. These means can also be the subject of separate kits.

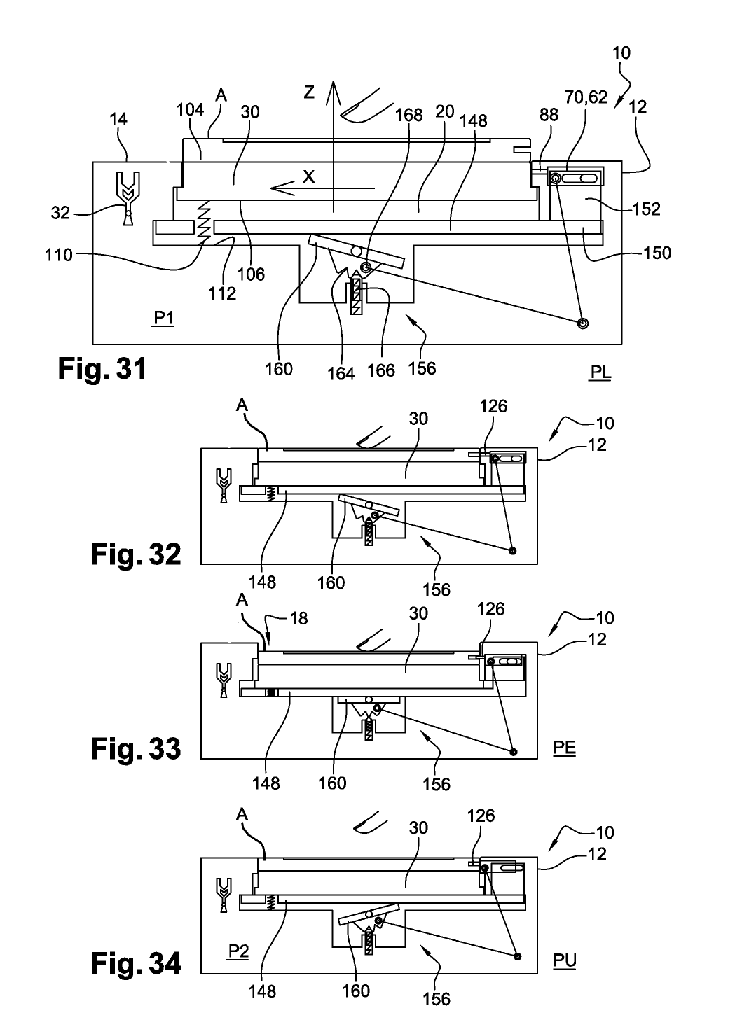

In another embodiment now presented, the apparatus A can be placed in position, held, and connected by means of a mechanical device now described with reference to FIG. 31. In accordance with this embodiment, the movable support 30 is arranged in the housing 20 and can be displaced there vertically Z between an empty position PL, such as in FIG. 31, in which position the upper face 104 appears through the opening 18, the mobile apparatus A being just placed on the upper surface 104, and a depressed position PE—FIG. 33. The spring 110, or alternatively any other elastic means, arranged between the lower face 106 and the bottom 112 of the housing 20 permanently biases the movable support 30 towards the empty position PL. In a particular embodiment, the spring 110 can be held in position in a hollow location not shown provided in the bottom 112 of the housing. The lateral walls 108 form a shoulder which permits complementary engagement with a rim of the opening 18. This engagement allows in the empty position PL the shoulder to come into abutment against the said rim and, although biased vertically Z by the spring 110, the movable support 30 is immobilized its upper surface 104 appearing through the opening 18.

The equipment 12 is moreover provided with a second movable support 148 arranged under the first movable support 30, between the lower face 106 of the first movable support 30 and the bottom 112 of the housing. The second movable support 148 comprises a flat horizontal part 150 which extends parallel with the first movable support 30 and a vertical extension 152 which forms a parallelepipedal block so arranged as to be on the side of the apparatus A provided with a female connector. In FIG. 31 this vertical extension 152 is on the width situated on the right of the horizontal part 150. The horizontal part 150 is provided with a hole through which the spring 110 extends and the vertical extension 152 is itself provided with a hollow space 154 in which is arranged the equipped plate 126 described above.

The translations along the main axis Z of the apparatus A and of the first movable support 30 are transformed into longitudinal translations X of the equipped plate 126 by means of a new transmission mechanism 156 comprising the second movable support 148, a tipping plate 160 and a rod-crank device described below.

Under the second movable support 148 is arranged, in a cavity 158 formed in the bottom 112 of the housing, a plate 160 tipping about the transversal axis Y. The plate 160 is provided with a cam 162 the semicircular profile of which has two notches 164. The cam 162 is followed by a finger 166 permanently biased by a spring, or any other elastic means, against the profile of the cam 162. When the finger 166 lodges in one of the two notches 164 this defines a stable position of the plate 160. The two stable positions P1 and P2 of the plate 160 are positions inclined symmetrically one with the other in which the plate 160 is not parallel with the bottom 112 of the housing, one edge of the plate being in contact with the underneath of the second movable support 148. At an eccentric point 168 of the body of the cam 162 is mounted pivotably one of the ends of a crank 170 which extends up to another end in pivotal connection with a rod 172 which for its part extends to an end itself linked pivotably to the equipped plate 126. The three pivot connections are effected along the transversal axis Y.

Alternatively and as has been described elsewhere, rather than being exactly formed to the dimensions of a given apparatus A, the equipment 12 can be formed larger so as to accommodate a plurality of models of apparatus A and be provided with a specific adapter comprising a peripheral adapter and optionally a thickness adapter.

Moreover, as is shown diagrammatically on the left of the figure and without that for that matter being its true location, the first movable support 30 is provided with the heart-shaped cam 32 followed by a movable finger such as described above.

The steps for placing in position of the apparatus A are now described.

In accordance with FIG. 31, the equipment 12 is in the empty position PL the upper face 104 of the movable support 30 appearing through the opening 18. The apparatus A is placed on the movable support 30 and is then entirely outside the housing 20. The second movable support 148 is held in an intermediate upper position, both distant from the lower face 106 of the first movable support 30 and also distant from the bottom 112 of the housing 20. The tipping plate 160 is in the first stable position P1 inclined towards the right of the figure and thus pushes back the second movable support 148 upwardly. The stable position is provided by the finger 166 the tip of which is lodged in a notch 164 of the cam 162. The crank 170 and the rod 172 hold the equipped plate 126 entirely within the space 154.

In accordance with FIG. 32 a user presses on the apparatus A and depresses it until the first movable support 30 has sufficiently compressed the spring 110 and the lower face 106 of the first movable support 30 is in contact with the second movable support 148. At this point of depression of the first movable support 30, the connector 88 is exactly facing the female connector of the apparatus A. During this first phase of the depression of the apparatus A the second movable support 148, the equipped plate 126, and the transmission mechanism 156 have not moved.

In accordance with FIG. 33, continuing to press and without interrupting the depression movement of the apparatus A, the first movable support 30 pushes back the second movable support 148 until the latter is in contact with the bottom of the housing 112. In this displacement step, the second movable support 148 drives downwardly the vertical extension 152 and therefore the equipped plate 126 and in this movement the connector 88 remains aligned with the connector of the apparatus A. As it approaches the bottom 112 of the housing, the second movable support 148 obliges the plate 160 to pivot until it is in a horizontal position—FIG. 33—in surface abutment against the second movable support 148. In this horizontal position the finger 166 is between the two notches 164 on an apex of the profile of the cam which makes this position unstable. This tipping movement of the plate 160 has caused a displacement of the crank 170 and of the rod 172 which has longitudinally X displaced the equipped plate 126. In so doing the male connector 88 has plugged into the apparatus A and, as shown in FIG. 33, the connector 88 is approximately half-way plugged in.

In accordance with FIG. 34, the user releasing his pressure on the apparatus A, this rises again, the first movable support 30 now only being subject to the vertical force of the spring 110. Biased by the finger 166, the plate 160 continues to tip in the same direction until it is again in the other stable position P2 in which the finger 166 is in the other notch 164. This second part of the tipping of the plate 160 has continued to displace the electrical connector 88 which has become entirely inserted in the apparatus A. At the end of this upward displacement, the apparatus A is immobilized appearing through the opening 18 and is in the use position PU.

To remove the apparatus A it is sufficient to again press on the apparatus A, which again depresses it and causes the plate 160 to tip, this time in the other direction of rotation, the clockwise direction in the context of the figures. This rotation is transformed by the rod and the crank into a movement of disconnection of the connector 88, the equipped plate 126 going back into the space 154. Releasing the pressure, the apparatus A continues to rise and again leaves the housing 20 until it is in the empty position—FIG. 31—in which it can again be removed.

The vertical displacements of the first movable support 30 are marked by the travel of the finger in the profile of the heart-shaped cam 32.

Many alternatives can be derived from the embodiment described. Particularly the plate 160 can easily be replaced by an element of any form provided the tipping pushes the second movable support 148 towards the opening 18.

1. An arrangement for mounting a mobile apparatus in equipment having a decorative fascia in a motor vehicle, the decorative fascia being provided with an opening giving access to a housing able to receive the mobile apparatus, said arrangement comprising:
a base fixed to a bottom of a housing;
a movable support displaceable relative to the base between a depressed position in which the movable support is close to the base and an empty position in which the movable support is distant from the base, the movable support having a main wall configured to receive the mobile apparatus; and
a retaining device which holds the movable support in one of the depressed position and the depressed position, wherein when the movable support is in the depressed position a front face of the mobile apparatus appears through the opening and is in surface continuity with the decorative fascia (14) of the equipment (12) and, when the movable support is in the empty position the main wall of the movable support appears through the opening and is in surface continuity with the decorative fascia of the equipment.

2. The arrangement described in claim 1 comprising in addition an elastic means arranged between the movable support and the base, the elastic means permanently biasing the movable support towards the empty position.

3. The arrangement described in claim 1, wherein the movable support comprises a generic support independent of a model of mobile apparatus, and an interchangeable thickness adapter specific to the model of mobile apparatus, the thickness adapter being arranged on the generic support, a thickness of the thickness adapter being selected depending on a thickness of the mobile apparatus so that when the movable support is in the depressed position the front face of the mobile apparatus of the said model is in surface continuity with the decorative fascia.

4. The arrangement described in claim 1, said arrangement further comprising in addition an interchangeable peripheral adapter specific to the model of mobile apparatus, the peripheral adapter being arranged and fixed in the opening of the housing and provided with an opening specific to dimensions of the model of mobile apparatus, so that, the mobile apparatus being placed in position its front face entirely obturates the opening while being in surface continuity with the decorative fascia of the equipment.

5. The arrangement described in claim 1, wherein the retaining device comprises a cam and a finger, the cam being attached to one of the movable support and the base (22), and the finger being attached to one of the base and the movable support respectively, the cam and the finger cooperating so that in a determined relative position of the cam and of the finger the movable support is retained in the depressed position.

6. The arrangement described in claim 1, wherein the retaining device comprises a stop attached to the movable support which cooperates with a pressing surface attached to the decorative fascia so as to retain the movable support in the empty position.

7. The arrangement described in claim 1, wherein the main wall of the movable support includes a detachable and interchangeable decorative cover.

8. The arrangement described in claim 1, wherein the arrangement further comprises a device for holding in position the mobile apparatus in the location.

9. The arrangement described in claim 8 in which the said device comprises a plate displaceable between an open position in which the mobile apparatus can be placed in or removed from the location and, a closed position in which the mobile apparatus is held in position in the location.

10. The arrangement described in claim 9 in which the holding device is provided with an elastic means which, when in the closed position of the plate, applies a force to the mobile apparatus so that the mobile apparatus is held in position.

11. The arrangement described in claim 10 in which the holding device comprises in addition a second elastic means arranged on the plate so that, in the closed position of the plate the elastic means applies to the mobile apparatus concurrent forces applied at corners of the mobile apparatus so as to adjust the position of the mobile apparatus in the location.

12. The arrangement described in claim 8 further comprising an electrical connector suited to the mobile apparatus so that the mobile apparatus can be electrically recharged and be connected to an electronic network comprising other electronic devices.

13. The arrangement described in claim 12 in which the connector is arranged on the plate so that, in the open position the connector is distant from the mobile apparatus and, in the closed position the connector is moved towards and complementarily connected to the mobile apparatus.

14. The arrangement described in claim 9 further comprising a cam track against which is permanently biased a cam follower, the cam track, the follower reciprocally, being attached to the plate while the follower, the track reciprocally, is attached to the equipment, the follower travelling along the cam track between a first position reached when the plate is in the open position and a second position reached when the plate is in the closed position, the cam track being provided with at least one positioning notch in which the follower is engaged in the closed position of the plate so as to stabilize the said closed position.

15. The arrangement described in claim 9 further comprising a grasping means attached to the plate so that a user can manually displace the plate between the open position and the closed position.

16. The arrangement described in claim 8 further comprising an automatic means, one of motorized and magnetic, for displacement of the holding device.

17. The arrangement described in claim 16 comprising an electrical actuator controlling the displacements of the holding device and of the connector.

18. The arrangement described in claim 17 in which the displacements of the maintaining device and of the connector are controlled by the same actuator which is an electric motor provided with transmission means connecting the said electric motor, the holding device and the connector (88) so that the holding device and the connector are driven in a coordinated manner and that therefore in the retracted position of the holding device the connector is disconnected and, in the extended position the connector is connected.

19. The arrangement described in claim 18 comprising in addition a control means of the actuator so arranged that it is powered when the movable support is in the depressed position.

20. The arrangement described in claim 19 in which the control means comprises a sensor of the position of the movable support.

21. The arrangement described in claim 20 in which the position sensor is an electrical contactor arranged at the bottom of the housing and actuated by the movable support when this arrives in the depressed position.

22. The arrangement described in claim 17, wherein the control means comprises in addition a detector of the presence of the mobile apparatus on the movable support so that, in the empty position of the movable support, the presence of a mobile apparatus causes the automatic displacement of the movable support towards the depressed position.

23. The arrangement described in claim 8 further comprising a mechanical transmission means comprising a second movable support movable in translation along the main axis arranged cooperating with the first movable support, this second movable support being provided with a location in which the holding device is arranged slidingly along the longitudinal axis.

24. The arrangement described in claim 23 in which the mechanical transmission means comprises in addition a rod-crank system transmitting and transforming the displacements along the main axis of the second movable support into longitudinal displacements of the holding device.

25. A kit for the installation of a mobile apparatus of a particular model in equipment provided with a decorative fascia and with an arrangement formed in accordance with claim 1, the kit comprising:
a thickness adapter being able to fit onto the movable support, the thickness adapter having the dimensions specifically adapted to the model of mobile apparatus,
a peripheral adapter being able to be arranged and fixed in the opening of the housing and itself being provided with an opening specific to the dimensions of the model of mobile apparatus, so that
a mobile apparatus of the said model being placed in position, its front face entirely obturates the specific opening while being in surface continuity with the decorative fascia.
